(19) United States
(12) Patent Application Publication
(10) Pub. No.: US 2017/0326596 A1
(43) Pub. Date: Nov. 16, 2017

(54) Dent Detection Apparatus and Method

(71) Applicant: Norton (Waterford) Limited, Waterford (IE)

(72) Inventors: Sean Leane, Waterford (IE); Thomas Maher, Waterford (IE)

(73) Assignee: Norton (Waterford) Limited, Waterford (IE)

(21) Appl. No.: 15/535,236

(22) PCT Filed: Dec. 11, 2015
(86) PCT No.: PCT/EP2015/079436

§ 371 Date: Jun. 12, 2017

(30) Foreign Application Priority Data
Dec. 12, 2014 (GB) 1422170.9

(51) Int. Cl. B07C 5/06

(52) U.S. Cl. CPC B07C 5/06

(57) ABSTRACT

The present disclosure is in the technical field of dent detection in canisters. Accurate and consistent detection of dents in canisters has been a problem in the industry for some time. The present disclosure describes an apparatus and method that addresses this technical problem in a repeatable and easily implemented manner. There is provided a dent detection apparatus including a conduit dimensioned to be the maximum allowable diameter of a canister, a transportation portion for transporting a canister through the conduit and a rotation portion for rotating the canister as it passes through the conduit. A sensor detects when a canister stops rotating and gets stuck in the conduit and alerts the user. Thus faulty canisters can be detected and removed from production.

### TECHNICAL FIELD

The present invention relates to the detection of unwanted defects in the geometry or surface finish of cylindrical cans or canisters. In particular, the present invention is concerned with the detection of unwanted indentations (dents) or protuberances on the surface of canisters used in medical devices such as metered dose inhalers (MDI).

### BACKGROUND

Canisters used in MDI applications are manufactured to very high standards in terms of geometrical tolerances and surface finish. In an MDI application the quality of the canister must be close to perfect due to regulatory and customer requirements. Any minor defect leads to the canister with the defect being rejected or an entire batch being manually inspected.

MDI canisters are typically manufactured from aluminium or other light-weight materials. This makes MDI canisters prone to damage during conveying, filling and labelling.

A further complication is the speed with which canisters need to be processed and filled to meet customer demands whilst minimising manufacturing costs. Achieving the tolerances required by the medical industry at high manufacturing speeds presents significant technical barriers. For example, MDI canisters have extremely tight tolerances since any protuberance or dent of a significant size on the surface of the canister is regarded as an unacceptable cosmetic defect and may prevent the canister from being used in an inhalation device.

Whilst the manufacture of canisters is relatively common, preventing defects such as dents from occurring during handling is very difficult, particularly at high manufacturing speeds. Thus it is important that an accurate, fast and robust quality control system is used.

Conventional systems involve visual inspection of the canister. This may for example be an individual testing samples of canisters or by some form of automated visual assessment, such as video or still camera.

However conventional testing techniques are not highly accurate and either fail to detect damaged canisters or dramatically slow down the production lines as canisters are assessed.

The inventors have devised an alternative way to meet the strict requirements of the medical industry whilst allowing manufacturing speeds to be maintained. They have further devised a highly reliable apparatus which can be conveniently retrofitted to existing manufacturing lines.

### SUMMARY

Particular aspects and embodiments are set out in accompanying claims.

According to a first aspect a dent detection apparatus for a canister is provided. In particular, a dent detection apparatus for an MDI canister is provided. The apparatus includes a conduit, wherein the width of the conduit is equal to the maximum allowable diameter of the canister; a transportation portion arranged to transport a canister through the conduit; and a rotation arrangement arranged to cause rotation of the canister as it is transported through the conduit.

Advantageously the width of the conduit is selected so as to correspond to the acceptable geometry of the canister. The rotation arrangement ensures that the canister is rotated within the conduit as it passes along the conduit. This allows defects in canisters to be detected as will be further described below.

It has been identified that an indentation in the side wall of a canister, such as an MDI canister, will cause some form of protuberance or projection extending from the outer wall of the canister. If the dent is very small, then the corresponding projection is also likely to be small. Small projections can be tolerated but at a certain defect tolerance the canister's cosmetic finish specification limit has been exceeded and the canister can no longer be safely used in an inhalation device.

A defect tolerance can thereby be determined below which the defect will not interfere with the functionality and use of the canister, or the aesthetic appearance of the canister before sale. The defect tolerance corresponds to the radial distance a defect extends beyond the outer radius of an undamaged canister. Put another way: the maximum allowable diameter of the canister at any point around the circumference is the nominal diameter plus the defect tolerance. If the diameter measurement at a particular location exceeds the maximum allowable diameter then the canister should be rejected.

According to the invention the geometry of the defect in combination with rotation of the canister can itself be used to identify defective canisters.

By defining the width of the conduit with respect to the desired defect tolerance the conduit (also herein termed channel) can be spaced such that a canister with a defect greater than the defect tolerance will engage in the channel and will not continue to rotate.

For example, if a canister has a diameter within the defect tolerance then it will continue to rotate within the channel. If the canister has a defect causing a projection which is dimensionally beyond the defect tolerance then as the canister rotates the projection will engage with one wall of the channel and the opposing side of the canister with the opposing side of the channel. Further rotation of the canister is thereby prevented.

The width of the conduit may be between 15 mm and 100 mm. One example width of the conduit is 21.5 mm. These widths correspond to the diameter of canisters used in metered dose inhalers such as asthma inhalers. The conduit may however be arranged so that the width can be adjusted to allow the apparatus to handle different diameter canisters and different tolerances.

The transportation portion may be a first conveyor belt. Using a conveyor belt is a quick and efficient way of transporting products and thus allows for high volumes of canisters to be moved through the apparatus and assessed for dents.

The rotation arrangement may include a first portion provided on an interior side surface of the conduit. The rotation arrangement may further include a second portion provided on an opposing interior side surface of the conduit to the first portion. At least one of the first and second portions of the rotation arrangement may be a second conveyor belt.

Conveyor belts advantageously provide a smooth and uninterrupted moving surface against which the canister may engage. This minimises the risk of damage occurring to the canisters as they pass through the conveyor. For example the conveyor belts themselves may be a rubber or other semi-flexible material.

Alternatively at least one of the first and second portions of the rotation arrangement may be a plurality of rollers.

In a further alternative at least one of the first and second portions of the rotation arrangement is a belt and pulley system. The pulleys may be in the form of two rollers one arranged at either end of the conduits with a flexible member looping around both rollers. The flexible member could be a single rubber band for example arranged such that it contacts the canisters on an inner wall of the conduit to effect the desired rotation. The band (or in another arrangement plurality of bands) may be recessed into grooves or channels formed in the inner wall of the conduit.

Thus a variety of different devices for rotating canisters may be used.

The apparatus may include a tapered portion provided at the entrance to the conduit. This can act as a funnel to help guide canisters into the conduit and ensure the canisters are aligned in single file.

The rotation arrangement may extend along an interior side surface of the tapered portion. This allows canisters to begin rotation before entry to the conduit which ensures canisters are already rotating on entering the channel which can increase efficiency and reduce the length of channel required.

Advantageously the rotation arrangement may be arranged to cause the canister to complete at least a 360 degree revolution within the conduit. The rotation arrangement may be arranged to cause the canister to complete at least a 420 degree revolution within the conduit. By providing that each canister is rotated through at least a complete revolution, the entire outer surface of the canister is checked for dents.

An indication that a defective canister is passing through the apparatus may be brought to the attention of the operator in a number of ways.

In one arrangement the width of the conduit is adapted such that a canister having a defect beyond an acceptable limit will be caused to engage with the conduit inner walls as it rotates and lock in position (jam) preventing any further movement along the conduits. In effect the defective canister is ‘captured’ in the conduit owing to its dimensions being greater than the dimensions of the conduit.

Alternatively the apparatus may further include a sensor configured to detect if a canister stops rotating within the conduit. This might be by means of a video camera with suitable image processing apparatus or by means of a physical sensor arranged to detect a lack of rotation of individual canisters.

Thus a defective canister may be efficiently detected.

The apparatus may further include a notification system configured to provide a notification when the sensor detects that a canister has stopped rotating within the conduit. By providing a notification, an operator is alerted to the fact that a dented canister has been identified. The canister can then be manually removed from the production line and thus only undented cans are permitted to pass.

The notification portion may include a visual device such as a display screen on which an alert is displayed or a light. The notification portion may include an audio device. Thus an operator can be immediately informed when a dented can is identified.

The notification portion may additionally or alternatively be adapted to operate a part of the conveyor which automatically removes the defective canister from the production line. For example a side wall of a production line conveyor may be provided with an opening into which a defective canister could be pushed by an actuator in response to a control signal from the notification portion. Thus, a canister could be automatically removed without interrupting the production line and/or requiring the intervention of an operator.

According to a further aspect, there is provided a method of detecting dents in a canister, in particular an MDI canister. The method includes the steps of moving a canister through a channel, wherein the width of the channel is dimensioned to be the maximum allowable diameter of the canister; rotating the canister whilst it is moved through the channel; detecting when a canister stops rotating within the channel; and providing a notification when a canister stops rotating within the channel. By dimensioning the width of the channel to be the maximum allowable diameter of the canister, any dented canisters will necessarily stop rotating within the channel and are thus detected by the detector. A notification is then provided thus allowing all dented canisters to be identified and removed.

Viewed from another aspect, there is provided an apparatus for detecting defects in canisters, in particular metered dose inhaler canisters, comprising: a channel, a rotator arranged to rotate a can located within the channel, a detector arranged to detect when a can ceases to rotate within the channel, and a communication portion arranged to communicate when a can ceases to rotate within the channel.

In such an arrangement the rotator is adapted such that a canister with a defect on its surface cannot be rotated by the rotator i.e. forced to rotate. This may for example be achieved by limiting the torque that the rotator can apply to the canister so as to allow a defective canister to be detected.

Thus an alternative arrangement of a dent detection apparatus is provided.

Viewed from a further aspect, there is provided a canister, in particular an MDI canister, dent detection apparatus comprising a pair of opposing surfaces defining a channel therebetween and being spaced apart by a predetermined distance; wherein the predetermined distance is equal to the outer diameter of a canister plus a defect tolerance.

In such an arrangement the channel itself is configured with respect to a defect being greater than an acceptable threshold (a defect tolerance). It will be recognised that a canister with a defect greater than the tolerance is likely to engage with a wall of the channel as it travels along the channel unless the defect is facing in a forwards or backwards direction with respect to the direction of the channel. In such a situation the defect may not engage with the channel wall.

Thus, advantageously one or both of the opposing surfaces may be adapted to cause a canister to rotate as the canister passes through the channel. One or both surfaces may include a movable portion adapted to cause rotation of a canister. The movable portion may be in the form of a belt, roller, band or conveyor integrated into a side surface and against which a canister may engage. A variety of different devices that cause rotation of the canister can therefore be utilised.

The opposing surfaces may have differing coefficients of friction so as to cause a canister to rotate. For example one of the opposing surfaces may have a higher coefficient of friction than the other. Thus rotation is achieved by the canister slipping against the surface with a lower coefficient of friction and being gripped by the surface with a higher coefficient of friction.

The predetermined distance between opposing surfaces may be selected such that a canister with a defect greater than a predetermined limit engages with one guide surface and an opposing side of the canister engages with the opposing guide surface thereby preventing the canister travelling along the channel.

A canister may be caused to rotate by at least one complete revolution as it passes along the channel. Thus the entire surface of the canister can be assessed to ensure compliance with the desired dimensional tolerance.

One or both surfaces may include a movable portion adapted to cause rotation of a canister. Thus a means for rotating the canister is provided.

Viewed from a further aspect, the present invention provides a method of manufacturing a plurality of metered dose inhalers comprising the steps of: providing a plurality of metered dose inhaler canisters; detecting canisters with dents within said plurality of metered dose inhaler canisters using a device, method, or the apparatus according to the previously disclosed aspects of the invention; discarding canisters with dents so detected; and assembling a plurality of metered dose inhalers using the remaining canisters. Assembling the plurality of metered dose inhalers will typically comprise inserting each canister into a metered dose inhaler actuator body.

Further feature combinations provided by the present teachings will be understood from the following detailed description and the accompanying figures.

### DESCRIPTION OF DRAWINGS

The present teachings will now be described by way of example only with reference to the following figures in which like parts are depicted by like reference numerals:

FIG. 1 illustrates a dented canister;

FIG. 2 is an enlarged view of region A in FIG. 1;

FIG. 3 is a top view of a dent detection apparatus;

FIG. 4 is a schematic view of the dent detection apparatus of FIG. 3;

FIG. 5 is a flow diagram illustrating steps in an example process;

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention is covering all modifications, equivalents and alternatives falling within the spirit and the scope of the present invention as defined by the appended claims.

### DETAILED DESCRIPTION

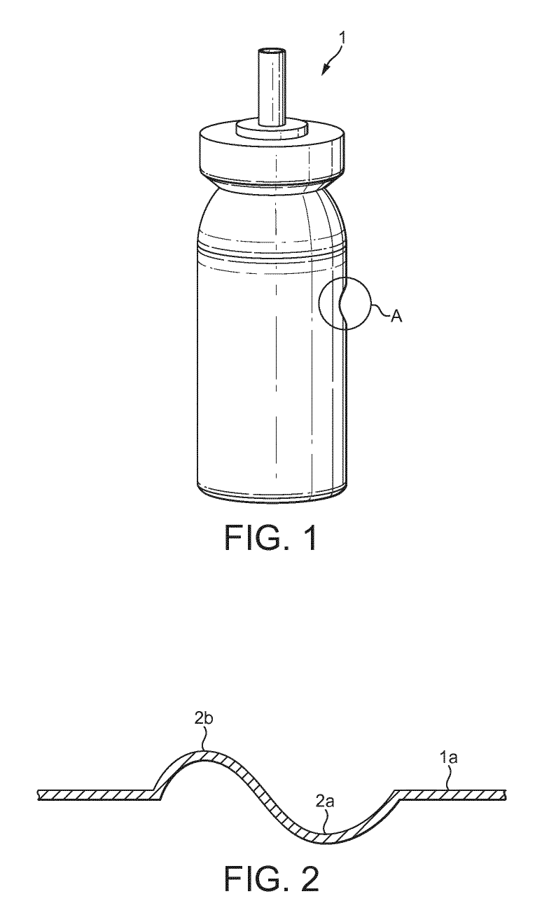

FIG. 1 shows a metered dose inhaler canister. The inhaler canister comprises a cylindrical outer body with a generally smooth outer surface and a metering valve. The canister is formed of aluminium or another other suitable material.

In FIG. 1 the canister has been damaged and comprises an indentation A on a side wall of the canister. This may for example be caused in transportation or through the filling or labelling process. As discussed above the presence of indentations is undesirable in canisters in particular canisters which are inserted into inhaler devices.

FIG. 2 is an enlarged view of the indentation (2a) in the surface of a canister in cross-section.

A consistent feature of an unwanted indentation in a canister is a corresponding protrusion to the side wall of the can. This might for example be caused by the can striking a conveyor wall at an angle causing material to be deformed and an indentation and protrusion being formed. As shown in FIG. 2 the dent (2a) in a surface (1a) results in a corresponding protrusion (2b) adjacent to the indentation (2a). It is this property of an indentation that is exploited in the present disclosure in order to accurately detect dents in the circumferential surface of a canister.

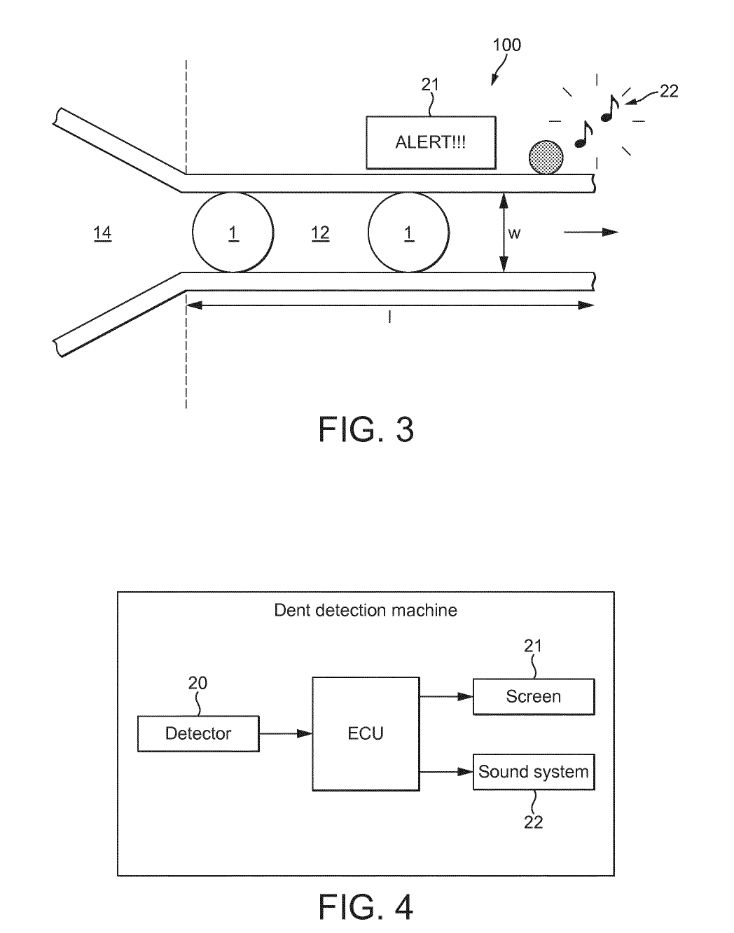

FIG. 3 is a top view of a dent detection apparatus (100) according to the present disclosure. The apparatus is suitable for placing into production and conveyor lines at various stages of a metered dose inhaler process including conveying, filling and labelling. However, it is most suited for analysis of canisters before filling so as to prevent unnecessary filling of damaged canisters with medicament.

The dent detection apparatus (100) has a channel or conduit (12) through which canisters (1) are conveyed.

The channel (12) is formed of two parallel opposing surfaces separated by a distance w. Distance w is dimensioned to be the maximum acceptable diameter of the canisters (1).

In an example where the canisters (1) are for use in asthma inhalers distance w is 21.5 mm but may be between 15 mm and 100 mm.

However the skilled person will appreciate that the apparatus can be used for any sized canister by altering the width of the conduit according to the desired diameter of the canister. A particular sized canister can be used to set the width of the conduit and can be used to retest the apparatus at regular intervals to ensure the apparatus is still operating effectively.

Canisters may travel along conveyors in a production facility as wide flows of canisters more than 1 canister wide. Thus, the apparatus has a tapered portion (14) leading into the entrance to the conduit (12) in order to focus canisters towards the entrance of the conduit (12) and to bring the canisters into single file for assessment.

Alternatively or additionally canisters may travel along the conveyors in a production facility as a continuous line of touching cans. A mechanism may therefore be provided to separate the canisters prior to entry to the conduit such that each individual canister may be freely rotated.

In order to transport canisters (1) through the apparatus (100) a first conveyor belt is provided on the base of the conduit (12). This may be a conventional conveyor belt used in canister processing. Canisters (1) are placed on the conveyor belt and conveyed through the conduit (12).

The apparatus is configured such that as a canister (1) is carried through the conduit (12) it is rotated by at least 360 degrees. In one example each canister (1) completes 1.2 revolutions whilst passing through the conduit (12). In this manner every possible diameter of a canister (1) is compared to the width of the conduit (12) (which is the maximum acceptable diameter of a canister).

In order to rotate a canister (1) as it passes through the conduit (12), a second conveyor belt is provided on an interior side surface of the conduit. When a canister (1) enters the conduit it touches the second conveyor belt and is thereby rotated as it passes through the conduit (12). The second conveyor belt may be arranged to start at a position along the length of the interior side surface of the tapered portion (14). In effect the tapered channel may itself have a side wall that is moving relative to the base (the first) conveyor on which the canister is being conveyed. In such an arrangement as the canister moves along the tapered portion towards the conduit or channel it eventually makes contact with the second conveyor and is caused to rotate. Thus, a canister (1) can begin to be rotated before it enters the conduit (12). This allows the channel to be as short as possible in length.

The relative speeds of the base (first) and side (second) conveyors are selected to ensure the canisters each make a full revolution before they exit the channel. This ensures that any protrusion on an outer surface of a canister comes into contact with a side wall (to effect blockage of the channel) or sensor (to indicate a defective canister).

The conveyors may alternatively or additionally move in different directions.

In one example a third conveyor belt is provided on the opposing interior side surface of the conduit (12) to the second conveyor belt. The combination of the second and third conveyor belts is used to rotate a canister (1) as it passes through the conduit (12).

Due to the width of the conduit (12) being dimensioned to be the maximum allowable diameter of a canister (1), when a dented canister is rotated within the conduit (12) it will jam or become stuck in the conduit (12) since the protrusion adjacent to the dent results in the diameter of the canister at the protrusion being greater than the width of the conduit (12).

In order to prevent the dented canister (1) from permanently blocking the apparatus, a detector is provided along the length of the conduit (12) in order to detect any canister that has stopped rotating and is therefore jammed in the conduit (12). The jammed canister is a faulty canister since it has a diameter greater than maximum allowed diameter and therefore needs to be permanently removed from production.

FIG. 4 illustrates a schematic drawing of an in-vehicle apparatus according to the present example. The system of the present example includes a sensor (20) operable to detect when a canister has stopped rotating within the conduit.

In one example the sensor is a sensor arrangement formed from a plurality of retro reflective LED sensors placed along the length of the conduit. In operation when a canister passes the first sensor the system expects to see the canister pass the next sensor within a certain period of time. If the sensor does not detect the passage of the canister within the relevant time period then a notification is provided to the operator.

In an alternative example only a single sensor is used at the exit of the conduit. In this example the sensor detects canisters exiting the conduit. When no canister has been detected exiting the conduit for a certain period of time, a notification is provided to the operator informing them that a defective canister has been identified.

The sensor (20) is connected to an electronic control unit (ECU) which processes the detection results generated by the detector (20) and sends signals to a notification device in accordance with the results of the detector (20). The notification device may be a visual device such as a screen (21) or light located adjacent to the apparatus, or any other visual device capable of providing a visual notification to the user. The notification device may be an audio device operable to play a sound in order to provide a notification to the user. In one example both a visual and an audio device may be used in order to provide both visual and audio alerts to the user. In one example the notification device is a Man Machine Interface Display. The user on receiving the alert knows that a faulty canister has been detected and can remove the canister from production.

Although in the example illustrated a single conveyor belt is used to rotate canisters within the apparatus, other alternative arrangements can also be used. For example in one alternative a plurality of narrower conveyor belts may be provided on the interior of the conduit. In an alternative embodiment a series of rollers can be used to rotate the canisters.

In one particular embodiment rotation of canisters is achieved due to differing frictional properties of the two interior side surfaces of the channel. For example one interior side surface may have a high coefficient of friction whereas the other interior side surface may have a low coefficient of friction. This may for example be realised by applying a rubber strip or bead (or other suitable material) along the inner surface of one side of the channel. As the canisters travel along the channel one side engages with the bead and the canister is caused to roll and rotate by means of contact with the bead. This allows for a very simple construction and removes the need for a side conveyor arrangement. It has been identified that this embodiment may be useful for canister detection in technical fields outside the pharmaceutical environment.

Although the apparatus has been described as having a single sensor, in an alternative example a plurality of sensors arranged along the length of the conduit may be used.

Although the apparatus has been described as having a first conveyor belt, in an alternative embodiment the apparatus may be retrofitted to an existing conveyor belt on a production line and thus the apparatus itself does not include a first conveyor belt.

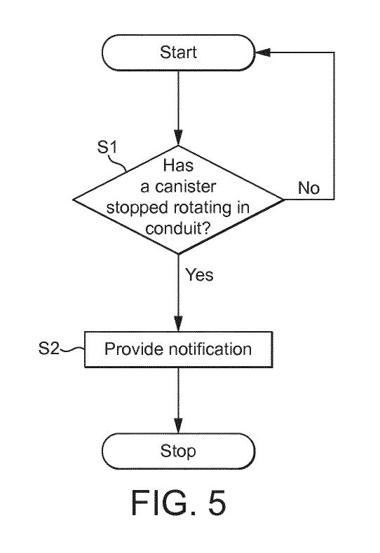

FIG. 5 illustrates a flow chart of steps carried out in this example. S1 is a detection step during which it is detected whether a can has stopped rotating in the conduit. If it is detected that a can has stopped rotating in the conduit the method continues to step S2. If it is detected that the canister keeps moving through the conduit then the method returns to the start.

S2 is a notification step during which notification is provided that a canister has stopped rotating within the conduit. The notification may be a visual and/or audio notification and may be provided using the visual and/or audio devices of the apparatus. Once the notification has been provided the method ends.

Thus there has now been described an example of an apparatus and method whereby a detection of a dented canister can be made and a notification provided to the user of the apparatus so that the dented can may be removed from production.

1. A dent detection apparatus for a metered dose inhaler canister, the apparatus comprising:
a conduit, wherein the width of the conduit is equal to a maximum allowable diameter of the canister;
a transportation portion arranged to transport a canister through the conduit; and
a rotation arrangement arranged to cause rotation of the canister as it is transported through the conduit; wherein rotation of the canister within the conduit causes a protrusion on the canister to engage with a wall of the conduit.

2. An apparatus according to claim 1 wherein the width of the conduit is between 15 mm and 100 mm.

3. An apparatus according to claim 2 wherein the width of the conduit is 21.5 mm.

4. An apparatus according to claim 1 wherein the transportation portion is a first conveyor belt.

5. An apparatus according to claim 1 wherein the rotation arrangement comprises a first portion provided on an interior side surface of the conduit.

6. An apparatus according to claim 5 wherein the rotation arrangement comprises a second portion provided on an opposing interior side surface of the conduit to the first portion.

7. An apparatus according to claim 6 wherein at least one of the first and second portions of the rotation arrangement is a second conveyor belt.

8. An apparatus according to claim 6 wherein at least one of the first and second portions of the rotation arrangement is a plurality of rollers.

9. An apparatus according to any of claim 6 wherein one interior side surface of the conduit has a surface finish with a high friction coefficient and wherein the opposing interior side surface of the conduit has a surface finish with a low coefficient of friction.

10. An apparatus according to claim 1 wherein the transportation portion and the rotation arrangement are configured such that a canister rotates at a different velocity to the velocity of the transportation portion.

11. An apparatus according to claim 1 comprising a tapered portion provided at an entrance to the conduit.

12. An apparatus according to claim 11 wherein the rotation arrangement extends along an interior side surface of the tapered portion.

13. An apparatus according to claim 1 wherein the rotation arrangement is arranged to cause the canister to complete at least a 360 degree revolution within the conduit.

14. An apparatus according to claim 1 wherein the rotation arrangement is arranged to cause the canister to complete at least a 420 degree revolution within the conduit.

15. An apparatus according to claim 1 comprising a sensor arrangement configured to detect if a canister stops rotating within the conduit.

16. An apparatus according to claim 15 wherein the sensor arrangement comprises a plurality of sensors arranged along the length of the conduit.

17. An apparatus according to claim 15 wherein the sensor arrangement comprises a single sensor arranged at the exit of the conduit.

18. An apparatus according to claim 15 comprising a notification portion configured to provide a notification when the sensor arrangement detects that a canister has stopped rotating within the conduit.

19. A dent detection apparatus according to claim 18 wherein the notification portion comprises a visual device.

20. A dent detection apparatus according to claim 19 wherein the visual device comprises a screen or light.

21. A dent detection apparatus according to claim 18 wherein the notification portion comprises an audio device.

22. A method of detecting dents in a metered dose inhaler canister, the method comprising:
moving a metered dose inhaler canister through a channel, wherein the width of the channel is dimensioned to be the maximum allowable diameter of the canister;
rotating the canister whilst it is moved through the channel;
detecting when a canister stops rotating within the channel; and
providing a notification when a canister stops rotating within the channel.

23. A method according to claim 22 wherein the rotating step comprises rotating the canister through at least a 360 degree revolution within the channel.

24. A method according to claim 23 wherein the rotating step comprises rotating the canister through a 432 degree revolution within the channel.

25. A method according to claim 22 wherein the width of the channel is between 15 mm and 100 mm.

26. A method according to claim 25 wherein the width of the channel is 21.5 mm.

27. A method according to claim 22 wherein the notification is a visual alert.

28. A method according to claim 22 wherein the notification is an audio alert.

29. An apparatus for detecting faults in metered dose inhaler canisters comprising:
a channel,
a rotator arranged to rotate a canister located within the channel,
a detector arranged to detect when a canister ceases to rotate within the channel, and
a communication portion arranged to communicate when a canister ceases to rotate within the channel.

30. A metered dose inhaler canister dent detection apparatus comprising a pair of opposing surfaces defining a channel therebetween and being spaced apart by a predetermined distance; wherein the predetermined distance is equal to the outer diameter of a canister plus a defect tolerance.

31. An apparatus according to claim 30 wherein one or both of the opposing surfaces are adapted to cause a canister to rotate as the canister passes through the channel.

32. An apparatus according to claim 31 wherein one or both of the opposing surfaces comprise a movable portion adapted to cause rotation of a canister.

33. An apparatus according to claim 32 wherein the movable portion is in the form of a belt, roller, band or conveyor integrated into a side surface and against which a canister may engage.

34. An apparatus according to claim 31 wherein the opposing surfaces have differing coefficients of friction so as to cause a canister to rotate.

35. An apparatus as claimed in claim 30 wherein the predetermined distance between opposing surfaces is selected such that a canister with a defect greater than a predetermined limit engages with one guide surface and an opposing side of the canister engages with the opposing guide surface thereby preventing the canister travelling along the channel.

36. An apparatus as claimed in claim 31 wherein a canister is caused to rotate by at least one complete revolution as it passes along the channel.

37. An apparatus according to claim 30 wherein one or both surfaces comprises a movable portion adapted to cause rotation of a canister.

38. A method of manufacturing a plurality of metered dose inhalers comprising the steps of:
providing a plurality of metered dose inhaler canisters;
detecting canisters with dents within said plurality of metered dose inhaler canisters using a device according to claim 1;
discarding canisters with dents so detected; and
assembling a plurality of metered dose inhalers using the remaining canisters.

39-40. (canceled)

41. A method of manufacturing a plurality of metered dose inhalers comprising the steps of:
providing a plurality of metered dose inhaler canisters;
detecting canisters with dents within said plurality of metered dose inhaler canisters using the method according to claim 22;
discarding canisters with dents so detected; and
assembling a plurality of metered dose inhalers using the remaining canisters.

42. A method of manufacturing a plurality of metered dose inhalers comprising the steps of:
providing a plurality of metered dose inhaler canisters;
detecting canisters with dents within said plurality of metered dose inhaler canisters using the apparatus according to claim 29;
discarding canisters with dents so detected; and
assembling a plurality of metered dose inhalers using the remaining canisters.
